(19) United States
(12) Patent Application Publication
(10) Pub. No.: US 2005/0206303 A1
(43) Pub. Date: Sep. 22, 2005

(54) Organic EL panel and method of manufacturing the same

(75) Inventors: Isamu Ohshita, Yamagata-ken (JP); Toshinao Yuki, Yamagata-ken (JP)

Correspondence Address: ARENT FOX PLLC, 1050 CONNECTICUT AVENUE, N.W., SUITE 400, WASHINGTON, DC, 20036, US

(73) Assignee: Tohoku Pioneer Corporation

(21) Appl. No.: 11/079,111

(22) Filed: Mar. 15, 2005

(30) Foreign Application Priority Data
Mar. 17, 2004 (JP) JP 2004-76086

(51) Int. Cl. H05B 33/00; H05B 33/02

(52) U.S. Cl. 313/503; 313/504; 445/24

(57) ABSTRACT

An organic EL panel which is formed by controlling the thickness of a lower electrode while at the same time improving the surface flatness of the lower electrode which serves as a support substrate for an organic layer. Films are formed through several times of film-formation on a substrate and polished to form the lower electrode serving as a substrate for an organic layer with a polished surface. In this case, a first film formation produces a first film, while second and later film formations produce other film layers which is thicker than the first film layer. Further, the formed films are polished by a thickness larger than the total thickness of films formed during the second and later film formations, thereby forming the polished surface.

### BACKGROUND OF THE INVENTION

The present invention relates to an organic EL (Electroluminescence) panel and a method of manufacturing the same.

The present application claims priority from Japanese Application No. 2004-76086, the disclosures of which are incorporated herein by reference.

An organic EL panel is produced by forming surface emission element(s) based on organic EL device(s) on a substrate, and forming a display area by arranging one or more such surface emission element(s). Here, each organic EL device is obtained by forming a lower electrode (having one of various structures) on the substrate, and forming an organic layer containing an organic luminescence layer, followed by forming thereon an upper electrode.

FIG. 1 is a sectional view showing a cross section of an organic EL (element) device 10 for use in forming a conventional organic EL panel. As shown, the organic EL device 10 mounted on a substrate 11 has a laminated structure formed by interposing an organic layer 20 containing an organic luminescence layer between a pair of electrodes. Further, insulating films 13 are formed around a lower electrode 12 on the substrate 11, while an area on the lower electrode 12 surrounded by the insulating films 13 forms a luminescent area S. Moreover, in the luminescent area S, the organic layer 20 is laminated on the lower electrode 12, while an upper electrode 14 is formed on the organic layer 20.

As one example, the organic layer 20 has a three-layer structure including a hole transporting layer 21, a luminescent layer 22, and an electron transporting layer 23, with the lower electrode 12 serving as an anode and the upper electrode 14 as a cathode. However, it is also possible to form a structure not including the hole transporting layer 21 and/or the electron transporting layer 23, or a structure in which at least one of the aforementioned layers is formed into a multi-layered structure. Alternatively, it is also possible to form a hole injection layer on the anode side of the hole transporting layer 21, and an electron injection layer on the cathode side of the electron transporting layer 23. In addition, it is further possible for the lower electrode 12 to be used as a cathode and the upper electrode 14 as an anode.

Such an organic EL device for use in forming an organic EL panel, once under an electric voltage applied between the lower electrode 12 and the upper electrode 14, allows positive holes to be injected and transported from the anode side to the organic layer 20, and electrons to be injected and transported from the cathode side to the organic layer 20, thereby effecting a light emission through a recombination of the positive-holes with electrons. For this reason, the organic layer 20 interposed between the lower electrode 12 and the upper electrode 14 is required to have a uniform thickness. If there is a thin portion locally existing in the organic layer 20 within the luminescent area S, an electric current (leak current) will be generated in such a thin portion, resulting in an emission failure.

In order to ensure a uniform thickness for the organic layer 20, it is important to improve the flatness of the lower electrode 12 serving as a support base for the organic layer 20. If a display panel is a bottom emission type emitting light from the substrate 11 side, the lower electrode 12 is usually formed by a transparent conductive film such as ITO (Indium-Tin-Oxide), through sputtering deposition or electron-beam (EB) deposition. However, since an allowable maximum height (Rmax) of the surface roughness defined by JIS B0601 is in a range of several nm to several tens of nm, the thickness of the organic layer 20 formed in any of these conventional methods is unfavorable because such thickness is 100 to 200 nm.

In order to avoid the above problem, Japanese Unexamined Patent Application Publication Hei 9-245965 suggests that the surface of the lower electrode consisting of ITO formed by sputtering or electron-beam deposition is polished so as to control the maximum height (Rmax) of the surface roughness defined by JIS B0601 at 5 nm or less.

According to the above-mentioned patent publication, the surface of the lower electrode is polished by several tens of nm so that convex portions on the surface can be removed. However, such method fails to remove some heavily concave portions.

In particular, where foreign things adhere to the surface of the lower electrode and some defects (such as pinhole) occur, it is difficult to eliminate defects such as concave portions no matter how hard one tries to polish the surface.

Moreover, if a display panel is a bottom emission type emitting light from its substrate side, the thickness of its lower electrode is required to be controlled according to the color of emitted light, so as to ensure that the spectrum of the emitted light exhibits a desired peak wave length. Namely, emitted light occurred within the organic layer 20 contains a light component which is reflected repeatedly by interfaces between various layers and then penetrates through the transparent conductive film (lower electrode) so as to be emitted out. For this reason, although an organic EL device itself will function as an optical interference filter, when considering the thickness of the lower electrode, a light outputted after being reflected by an interface between the organic layer and the lower electrode will have an interference with a light outputted after being reflected by an interface between the lower electrode and the substrate, thus causing a change in the spectrum of output light. Accordingly, an important factor in designing an organic EL panel should be such that it is possible to control the thickness of the lower electrode when forming the organic EL panel.

However, if merely the surface of a lower electrode is polished as in a conventional method, since a thickness to be polished away depends on the surface roughness of the lower electrode, it will be difficult to control the thickness of a finally formed lower electrode to a predetermined value. That is, if a lower electrode is formed with a thickness t1 in an initial step and then the surface thereof is polished away by a predetermined thickness ts, it is allowed to set the thickness of a finally formed lower electrode at t1−ts. This, however, can not completely ensure that a desired surface flatness will be obtained. As a result, if merely the surface flatness is sought, it is substantially impossible to set the polishing thickness ts at a predetermined value. Consequently, it is impossible to obtain a finally formed lower electrode with a desired thickness.

### SUMMARY OF THE INVENTION

The present invention has been accomplished to solve the above-discussed problem. Namely, one object of the present invention is to prevent a leak current and thus obtain an acceptable luminescent characteristic by flattening the surface of the lower electrode and forming an organic layer with a uniform thickness on the lower electrode. This particularly makes it possible to produce an acceptable lower electrode with a flat surface, even under a condition wherein some defects occur on the film serving as the lower electrode. Another object of the present invention is to control the thickness of the lower electrode to a desired value while at the same time ensuring a required surface flatness for the lower electrode.

In order to achieve the above objects, an organic EL panel and its manufacturing method according to the present invention are characterized by at least the following aspects.

According to one aspect of the present invention, there is provided an organic EL panel produced by forming an organic EL device on a substrate. Such an organic EL device comprises a lower electrode, an organic layer containing at least one organic luminescence layer, and an upper electrode. In particular, the lower electrode has a polished surface formed by polishing films formed through several times of film formation.

According to another aspect of the present invention, there is provided a method of forming an organic EL panel, including forming an organic EL device on a substrate. Such an organic EL device comprises a lower electrode, an organic layer containing at least one organic luminescence layer, and an upper electrode. The method comprises the steps of: forming, on the substrate, films having a predetermined thickness through several times of film formation; and polishing the formed films by a predetermined thickness to form the lower electrode having a desired thickness.

### BRIEF DESCRIPTION OF THE DRAWINGS

These and other objects and advantages of the present invention will become clear from the following description with reference to the accompanying drawings, wherein:

FIG. 1 is an explanatory view showing a conventional technique; and

FIGS. 2A to 2C are explanatory views showing an embodiment of the present invention.

### DETAILED DESCRIPTION OF THE PREFERRED EMBODIMENTS

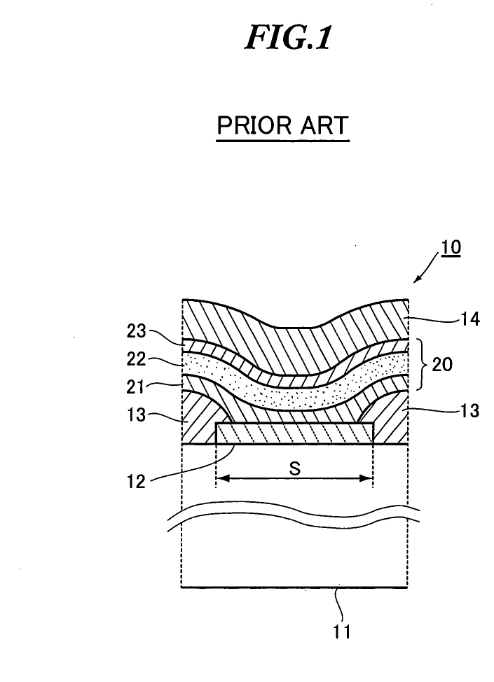

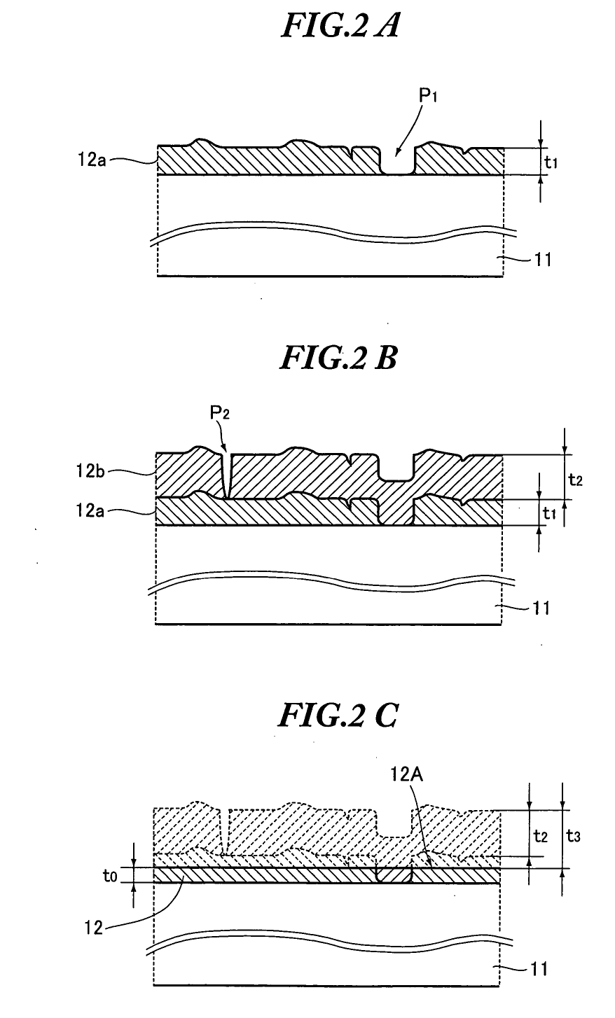

Hereafter, a preferred embodiment of the present invention will be described with reference to the accompanying drawings. FIGS. 2A to 2C are explanatory views showing an organic EL panel and its manufacturing method according to one embodiment of the present invention. In fact, the organic EL panel and its manufacturing method are substantially the same as the conventional technique shown in FIG. 1. Namely, the organic EL panel includes a substrate 11 and at least one organic EL (element) device mounted on the substrate 11, with each organic EL device including a lower electrode 12, an organic layer 20 containing at least one organic luminescence layer, and an upper electrode 14. In this way, a display area can be formed with each organic EL device serving as a displaying unit. Therefore, in the following description of the embodiment of the present invention, the same elements as those shown in FIG. 1 will be represented by the same reference numerals.

As shown in FIG. 2, the organic EL panel according to the present embodiment of the present invention is characterized in that its lower electrode 12 has a polished surface 12A formed by polishing several layers of films (12a, 12b) formed during several times of film formation. Further, the lower electrode 12 is characterized by having a thickness t0 which is thinner than the thickness t1 built during the first film formation.

Namely, the lower electrode 12 is characterized by having a thickness t0 which is t1+t2−t3, wherein t1 represents a thickness obtained during a first film formation, t2 represents a total thickness obtained during second and later film formations (however, t2>t1), t3 represents a polishing thickness for polishing away the films (12a, 12b) (however, t3>t2).

Further, the method of manufacturing the organic EL panel is characterized in that films (12a, 12b) having predetermined total thickness are formed on the substrate 11 through several times of film formation, followed by polishing away the formed films (12a, 12b) by the predetermined thickness t3, thereby forming the lower electrode 12 having a desired thickness t0.

In addition, the present invention is characterized in that when films (12a, 12b) are formed, the total thickness t2 obtained during the second and later film formations is made thicker than the thickness t1 built during the first film formation, while the polishing thickness t3 for polishing away the films (12a, 12b) is made thicker than the thickness t2 obtained during the second and later film formations. Moreover, controlling the polishing thickness t3 for polishing away the films (12a, 12b) makes it possible to adjust the thickness t0 of the lower electrode 12.

A method of forming an organic EL panel according to the present invention can be either a sputtering process or a thin film formation process. When using sputtering, it is found that once film thickness increases, surface irregularities will grow and this can result in an increased surface roughness. In contrast, a thin film formation process has been found capable of ensuring a relatively high surface smoothness. Therefore, it is preferable to employ a thin film formation process to form the lower electrode 12 through several times of film formation, thereby avoiding an increased surface roughness.

If the lower electrode 12 is formed by carrying out a film formation process only once, there is a possibility that a defect P₁ will occur as shown in FIG. 2A. On the other hand, if the lower electrode 12 is formed by performing several times of film formation as shown in FIG. 2B, even if another defect P₂ might occur during a second film formation, it is almost impossible for the defect P₁ occurred during the first film formation to be overlapped by the defect P₂ occurred during the second film formation. Therefore, if the lower electrode 12 is formed by performing several times of film formation, it is possible to ensure that there would be no concavity to be formed at least within the thickness t1.

Besides, since the formed films (12a, 12b) are polished until reaching a depth at which no concavity is involved, it is allowed to obtain the lower electrode 12 with a flat surface.

Furthermore, the polishing thickness t3 for polishing away the films (12a, 12b) is within a range of t2<t3<(t1+t2) as shown in FIG. 2C, so that it is possible to form a polished flat surface 12A not involving any concavity. In this way, by adjusting the thickness t3 within the above range, it is possible to desirably control the thickness t0 of the lower electrode 12 while at the same time ensuring a flat polished surface 12A.

A method of forming the lower electrode 12 includes a first film formation to form a film 12a having a thickness t1 which is thicker than the predetermined thickness t0 of the lower electrode 12, as shown in FIG. 2A. Then, as shown in FIG. 2B, second and later film formations are performed to form a film 12b having a thickness t2 which is thicker than the thickness t1 of the film 12a formed during the first film formation. Subsequently, as shown in FIG. 2C, the formed films (12a, 12b) are polished away by a thickness t3 (polishing thickness) which is thicker than the thickness t2 of the film 12b. At this time, if the polishing thickness t3 is properly adjusted within the range mentioned above, it is possible to form the lower electrode 12 having the flat polished surface 12A as well as the desired thickness t0 (which is thinner than the thickness t1 of the film 12a). In addition, the thickness of the lower electrode 12 can also be adjusted by adjusting film formation time and polishing time.

In this way, according to the present embodiment of the present invention, if the lower electrode 12 is formed by a transparent conductive film and light is emitted from the substrate 11 side, the peak wavelength of the spectrum of output light can be made coincident with the wavelength of emitted light (having a predetermined color) by controlling the thickness t0 of the lower electrode 12, thereby improving an emission efficiency of output light.

Therefore, using the organic EL panel manufacturing method according to the present embodiment of the present invention, it is possible to prevent a leak current and thus obtain an acceptable luminescence characteristic by flattening the surface of the lower electrode 12 and forming the organic layer 20 with a uniform thickness. This particularly makes it possible to produce an acceptable lower electrode with a flat surface, even under a situation in which a defect has once occurred within the film serving as the lower electrode. Moreover, it is possible to control the thickness of the lower electrode to a desired value while at the same time ensuring a required surface flatness for the lower electrode 12. In addition, it is even possible to obtain an effect of improving an emission efficiency of an output light.

Next, description will be given to explain in further detail various elements essential for forming an organic EL panel according to the present embodiment of the present invention.

a. Substrate

The substrate 11 of an organic EL panel may be formed into any desired shape such as a flat plate, a film, a spherical structure, and the like. As a material for forming such a substrate, it is allowed to employ glass, plastic, quartz, metal, etc. If a display panel is a bottom emission type which emits light from the substrate 11 side, its substrate can be formed into a flat plate or a film made of glass or plastic.

b. Electrodes

One of the lower electrode 12 and the upper electrode 14 is set as a cathode, while the other of them is set as an anode. The anode is formed by a material having a higher work function than the cathode, using a transparent conductive film which may be a metal film such as chromium (Cr), molybdenum (Mo), nickel (nickel), and platinum (Pt), or a metal oxide film such as ITO and IZO. On the other hand, the cathode is formed by a material having a lower work function than the a node, using a metal having a low work function, which may be a metal film formed by aluminum (Al), magnesium (Mg) or the like, or an amorphous semiconductor such as a doped polyaniline and a doped polyphenylene vinylene, or an oxide such as Cr₂O₃, NiO, and Mn₂O₅. Moreover, when the lower electrode 12 and the upper electrode 14 are all formed by transparent materials, it is allowed to provide a reflection film on one electrode side opposite to the light emission side.

c. Organic Layer

Although the organic layer 20 comprises one or more layers of organic compound materials including at least one organic luminescence layer, its laminated structure can be in any desired arrangement. Usually, as shown in FIG. 1, there is a laminated structure including, from the anode towards the cathode, a hole transporting layer 21, a luminescent layer 22, and an electron transporting layer 23. Each of the hole transporting layer 21, the luminescent layer 22, and the electron transporting layer 23 can be in a single-layer or a multi-layered structure. Moreover, it is also possible to dispense with the hole transporting layer 21 and/or the electron transporting layer 23. On the other hand, if necessary, it is allowed to insert other organic layers including a hole injection layer and an electron injection layer. Here, the hole transporting layer 21, the luminescent layer 22, and the electron transporting layer 23 can be formed by any conventional materials (it is allowed to use either a high molecular material or a low molecular material).

With regard to a luminescent material for forming the luminescent layer 22, it is allowed to use a luminescence (fluorescence) when the material returns from a singlet excited state to a base state or a luminescence (phosphorescence) when it returns from a triplet excited state to a base state.

d. Covering Member, Covering Film

Further, an organic EL panel according to the present invention is a panel formed by covering an organic EL device 10 with a covering member made of metal, glass, or plastic, or a panel formed by covering an organic EL device 10 with a covering film.

Here, the covering member may be a piece of material having a recess portion (a one-step recess or a two-step recess) formed by pressing, etching, or blasting. Alternatively, the covering member may be formed by using a flat glass plate and includes an internal covering space to be formed between the flat glass plate and the substrate by virtue of a spacer made of glass (or plastic).

The covering film can be formed by laminating a single layer of protection film or a plurality of protection films, and is allowed to be formed by either an inorganic material or an organic material. Here, an inorganic material may be a nitride such as SiN, AlN, and GaN, or an oxide such as SiO, Al₂O₃, Ta₂O₅, ZnO, and GeO, or an oxidized nitride such as SiON, or a carbonized nitride such as SiCN, or a metal fluorine compound, or a metal film, etc. On the other hand, an organic material may be an epoxy resin, or an acryl resin, or a paraxylene resin, or a fluorine system high molecule such as perfluoro olefin and perfluoro ether, or a metal alkoxide such as CH₃OM and C₂H₅OM, or a polyimide precursor, or a perylene system compound, etc. In practice, the above-mentioned lamination and material selection can be carried out by appropriately designing an organic EL device.

e. Various Types of Display Panels

An organic EL panel of the present invention can be a passive matrix type display panel or an active matrix type display panel. Although such a display panel may be a single color display or a multi-color display, forming a color display panel needs to adopt a discriminated painting method or a method in which a single color (white or blue) organic EL panel is combined with a color conversion layer formed by a color filter or a fluorescent material (CF manner, CCM manner), thereby making it possible to form a full color organic EL panel or a multi-color organic EL panel. Further, an organic EL panel of the present invention can be a bottom emission type allowing light emission from the panel substrate 11 side, or a top emission type allowing light emission from an opposite side away from the panel substrate 11 side.

### EXAMPLE

A further detailed example of the present invention will be described below. In fact, the following example relates to the formation of the lower electrode 12 having a thickness of 110 nm, which will become apparent with reference to FIG. 1 and FIG. 2.

At first, a first film-formation is carried out by forming a film 12a on a substrate 11 such as glass or the like, through sputtering, vapor-deposition or EB vapor-deposition of ITO or the like, in a manner such that the thickness t1 of the deposited film becomes: t1=140 nm (FIG. 2A). Next, a second film-formation is carried out by forming a film 12b having a thickness of 170 nm (namely, t2>t1) on the film 12a (FIG. 2B). Where the film-formation is carried out twice or more times, the film thickness t2 represents a total thickness of all films formed during the second and later film-formations.

Next, the films (12a, 12b) are polished away by a thickness of t3=200 nm (t3>t2), using an appropriate method such as polishing, lapping, tape-lapping or the like (FIG. 2C), thereby obtaining a lower electrode 12 having a total thickness of 110 nm and a flat polished surface 12A.

In this way, it is possible to reduce irregularities of the surface of the lower electrode 12, which have been considered as one factor responsible for a leak current of an organic EL device. Usually, if film formation is performed through sputtering or the like, there is a possibility that some immense defects will occur on the surface of the formed film layer due to an adherence of dust. However, the present invention makes it possible to avoid concavities caused by such film defects.

Then, the substrate 11 on which the lower electrode 12 has been formed is moved into a vacuum deposition apparatus to vapor-deposit an organic layer 20 on the lower electrode 12, using the same method as shown in FIG. 1. Here, the organic layer 20 can be obtained by forming: a hole injecting layer having a thickness of 30 nm and consisting of copper phthalocyanine; a hole transporting layer having a thickness of 50 nm and consisting of TDP or the like; a luminescent layer or electron transporting layer having a thickness of 20 nm and consisting of Alq₃ or the like; an electron injecting layer having a thickness of 1 nm and consisting of LiF. Further, an upper electrode 14 having a thickness of 100 nm and consisting of Al or the like, is formed on the organic layer 20, thereby forming an organic EL device 10 serving as an essential element for forming the organic EL panel of the present invention.

Next, a one-step recess portion is formed on a flat glass plate by performing etching on the flat glass plate. Then, a sheet-like desiccant containing BaO as its main component is attached into the one-step recess portion, thereby forming a covering member. Subsequently, one surface of the substrate 11 on which an organic EL device 10 has been formed, and one surface of the covering member on which the recess portion has been formed, are bonded together through an adhesive agent in a manner such that an internal space is formed therebetween, thereby forming an organic EL panel. When the bonding process is to be carried out, plastic spacers having a particle size of 1 to 100 μm are mixed at a ratio of 0.1 to 0.5 weight % into an amount of ultraviolet-setting epoxy resin adhesive so as to form an adhesive agent. Such an adhesive agent is applied to a bonding area of either the substrate 11 or the covering member using a dispenser or the like to bond together the substrate 11 and the covering member, followed by irradiating the adhesive agent with ultraviolet light so as to harden such an adhesive agent.

Therefore, an organic EL panel formed according to the present invention can prevent a leak current and thus ensure an acceptable light emission. Further, since it is possible to control the film thickness of the lower electrode 12, it is allowed to obtain an increased emission efficiency for output light.

While there has been described what are at present considered to be preferred embodiments of the present invention, it will be understood that various modifications may be made thereto, and it is intended that the appended claims cover all such modifications as fall within the true spirit and scope of the invention.

1. An organic EL panel produced by forming an organic EL device on a substrate, said organic EL device comprising a lower electrode, an organic layer containing at least one organic luminescence layer, and an upper electrode,
wherein the lower electrode has a polished surface formed by polishing films formed through several times of film formation.

2. The organic EL panel according to claim 1, wherein
the lower electrode has a thickness which is thinner than the thickness of a film formed during a first film formation.

3. The organic EL panel according to claim 1, wherein
the lower electrode has a thickness which can be represented by (t1+t2−t3), in which t1 represents the thickness of a film formed during a first film formation, t2 represents a total thickness of films formed during second and later film formations (t2>t1), t3 represents a polishing thickness for polishing away the formed films (t3>t2).

4. A method of forming an organic EL panel, including forming an organic EL device on a substrate, said organic EL device comprising a lower electrode, an organic layer containing at least one organic luminescence layer, and an upper electrode, said method comprising the steps of:
forming, on the substrate, films having a predetermined thickness through several times of film formation; and
polishing the formed films by a predetermined thickness to form the lower electrode having a desired thickness.

5. The method according to claim 4, wherein
when said films are formed, the total thickness of films formed during second and later film formations is thicker than the thickness of a film formed during a first film formation, and a polishing thickness for polishing away the formed films is thicker than the total thickness of the films formed during the second and later film formations.

6. The method according to claim 4 or 5, wherein
the thickness of the lower electrode is adjusted to a desired thickness by controlling the polishing thickness for polishing away the formed films.
